(19) United States
(12) Patent Application Publication
(10) Pub. No.: US 2010/0115623 A1
(43) Pub. Date: May 6, 2010

(54) SYSTEM AND METHOD FOR ENABLING DISTRIBUTION OF MEDIA CONTENT USING VERIFICATION

(75) Inventors: W. Eric Smith, Pleasant Grove, UT (US); James R. Gist, Draper, UT (US)

Correspondence Address: THORPE NORTH & WESTERN, LLP., P.O. Box 1219, SANDY, UT, 84091-1219, US

(73) Assignee: CONTROL4 CORPORATION, Draper, UT (US)

(21) Appl. No.: 12/262,109

(22) Filed: Oct. 30, 2008

(51) Int. Cl. H04L 9/32

(52) U.S. Cl. 726/27

(57) ABSTRACT

A system and method are provided to enable distribution of media content across a network using physical verification. The system includes a media server configured to send media content across a local network. A storage device can be in communication with the media server, and the storage device may store media content having encryption and provide the media content to the media server. A media reader that is in communication with the media server can be checked by the media server to determine whether a recording of the media content on removable physical media is loaded in the media reader in order to allow the media server to distribute the media content previously stored on the storage device. An output device can be enabled to receive media content from the media server and to reproduce the media content for an end user.

### BACKGROUND

The availability of home automation devices, large screen TVs, surround sound stereo equipment, DVDs, CDs, MP3s and similar electronic equipment has also increased consumer interest in networking such devices together. It has become easier and less expensive to buy many networkable components that can be used to control lighting, garage doors, monitor appliances, movie playback, music, broadcast television, satellite programs, cable programs, Internet connections, and other electronic components for a home automation network.

Many home automation devices and other systems can be networked into a central controller through a wired or wireless network. Examples of electronic components that an individual may desire to interface with a controller and home automation network can include: television screens, computer monitors, video projection systems, CD players, DVD players, VCRs, audio equipment, surround sound stereo equipment, video cameras, microphones and other audio-visual and entertainment equipment. Other types of devices that can be in communication with the controller can include home automation equipment such as: lighting control switches, fireplace relays, dimmers, thermostats, HVAC, timers, alarm systems and other types of home automation equipment. In addition, other home and business equipment can be connected to a central controller and home automation network such as: USB devices, FireWire devices, serial and parallel communication devices, fiber optic connections, a computer network using an Ethernet or wireless connection, and Internet connections. While the term home automation is used herein, these electronic components that have been described can be used in other settings, including business, education, government, hotels, churches, and entertainment facilities.

The ability to access media content and to distribute the media content or media programs via a local area network (e.g., wired or wireless) is important to those who purchase and use home automation networks. End users want to be able to copy DVD and Blu-Ray movies, CDs, video programs on other removable media, and various multi-media elements to a fixed mass storage drive (e.g., a hard drive) that is coupled to a media server or a controller in a home automation system. This way an end user can make a request to a media server and start a media program without actually playing the program from a playback device where the removable physical media is being read. Using a stored digital copy enables faster playback start times, eliminates delays, avoids congestion, and conveniently allows users to send a media program to any display or output device at any location within a building.

However, content providers and owners also desire to protect their media content from being freely copied and/or distributed by individuals who are not paying for a copy of the media program. As a result, copying a media program from optical disks to a central server for long-term storage is generally outside the licensing provisions of the providers of DVD content, Blu-Ray content and similar types of copy protected mediums. Accordingly, end users are not allowed to make and use digital copies of media programs for storage on a central server without violating licensing restrictions.

### SUMMARY OF THE INVENTION

A system and method are provided to enable distribution of media content across a network using physical verification. The system includes a media server configured to send media content across a local network. A storage device can be in communication with the media server, and the storage device may store media content having encryption and provide the media content to the media server. A media reader that is in communication with the media server can be checked by the media server to determine whether a recording of the media content on removable physical media is loaded in the media reader in order to allow the media server to distribute the media content previously stored on the storage device. An output device can be enabled to receive media content from the media server and to reproduce the media content for an end user.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of a system for enabling distribution of media content across a network using verification in accordance with an embodiment of the present invention;

FIG. 2 is a block diagram of a system for enabling distribution of media content that uses a multi-disk carousel for physical verification; and

FIG. 3 is a block diagram of a system for enabling distribution of media content across a network without using a controller in accordance with an embodiment of the present invention; and

FIG. 4 is a flow chart illustrating a method for enabling distribution of media content across a network.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

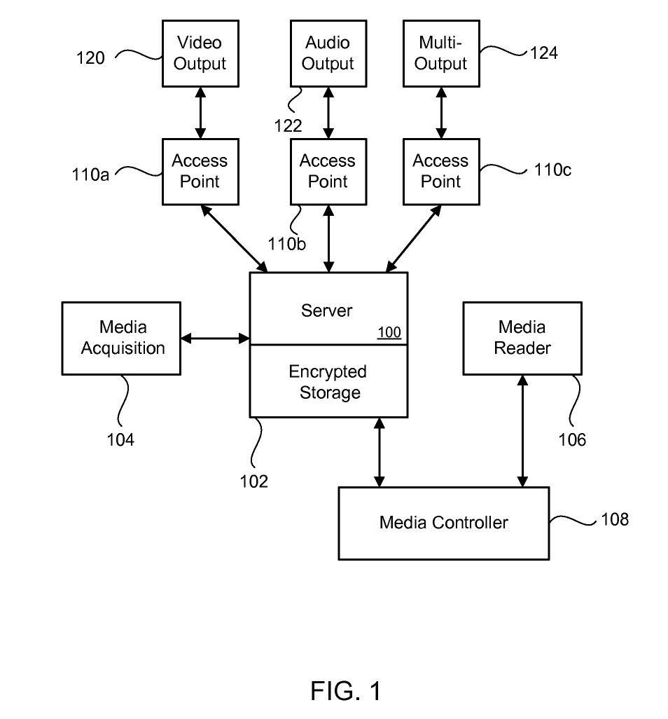

A system and method are provided to enable distribution of media content across a network using physical verification as illustrated in FIG. 1. The system can include a media server 100 configured to send media content across a local network. The local network can be a wireless network, such as a Wi-Fi or other network, or the local area network can be an Ethernet network or other wired network. A storage device 102 can be provided that is in communication with the media server. The storage device can store media content in an encrypted format. It is anticipated that the storage device may store a plurality of media programs which may include multiple movies, music albums, and multi-media content. In some cases, hundreds or even thousands of media programs can be stored.

When a request is received by the media server to play a certain program, the media content can be loaded into the server memory from the storage device so that it can be distributed across the local network. One method for distributing the media may be sending streaming audio or video that is synchronized to clocks in the server and receiving points. Alternatively, the media content can be sent asynchronously. Since the media program is encrypted in its stored state, the media content can be decrypted before the content is sent across the network or after the content arrives at its destination.

A media acquisition device 104 can be included in the system. The media acquisition device may be configured to electronically extract media content from a physical recording medium. In one embodiment, the media acquisition device can be an optical reader module configured to read a removable optical recording disk and decrypt the contents. For example, an optical reader drive may be used to read a DVD or Blu-Ray disk and to decrypt the contents so they can be stored in the same or a different encrypted format in the encrypted storage device 102. In other words, the media acquisition device can rip media content from a removable disk or storage medium so that the media content can be used within the home automation network and by the media server 100. Alternatively, the media acquisition device can be any type of media acquisition device able to accept a removable media module that stores a purchased copy of the media content (e.g., movie). Examples of other removable media maybe a Flash RAM device, magnetic tape, removable soft disks, removable hard disks, or similar removable storage systems.

A media reader 106 can be provided that is in communication with the media server 100. The media reader can be queried by the media server to determine whether a recording of the media content on removable physical media is loaded in the media reader in order to allow the media server to distribute the media content stored on the storage device. This means that a check is made to verify that the user has purchased a physical copy of the media program that is desired to be played, in order to allow the program to be accessed in its entirety. This is to ensure that unauthorized copying of the program contents has not taken place. In one embodiment, the media reader can hold multiple optical disks that can be switched for reading by an optical read head using a mechanical switching mechanism.

As an example, a user may place a DVD recording into the media acquisition device and make a request through the server 100 or media controller 108 for the DVD recording to be ripped or copied. This user request may be activated by the user making entries into a remote control, a touch screen interface, keyboard, pointing device, or another known type of interface that is interconnected with the controller. The ripped media content may then be stored in the storage device in an encrypted format so that it may not be copied further by a user. As described, the server device may be configured to only play the stored encrypted material after a query to the media reader has been made to verify that the corresponding physical media exists.

A number of querying variations may be employed in the verification of the existence of the matching physical media. In one embodiment, the media reader is checked for the existence of a purchased recording on a removable physical media after the media content has started playback in order to determine whether playback will be allowed to continue. If the purchased physical media for the media content exists, then the playback that has already started will be allowed to continue. Otherwise, if the physical media does not exist in the media reader then playback will be stopped. This enables the end user to get the fastest possible startup for playback but then the verification can take place to see whether the physical media exists within the system and that the media program has been properly purchased. In an alternative embodiment, the media reader is checked for the existence of a purchased recording on removable physical media before the media content can be sent or playback can be started.

The system may check for a physical copy of the media content each time the media content is played or it may periodically query to see that the physical media exists. For example, a media carousel may only be checked every other time or every fifth time, etc., that a media program is played. Alternatively, the verification may only take place randomly when playback is requested. This means that the system can randomly decide when the verification should be undertaken. In a similar manner, the physical media may be checked at random intervals or defined intervals during playback to ensure that the physical media is still loaded in the carousel during the entire playback period.

In an alternative embodiment of the invention, the media content file can be downloaded from a media service though the Internet. The media service can have users pay for the file they select for downloading and then maintain purchase verification information in a remote database. The downloaded media content can be locally stored in an encrypted format for the media server. When the file is requested to be played, the media server can make a query to the media service to verify that the end user who owns the server actually purchased the media content. If the media service's database results show the user has purchased the media content and the appropriate credentials were provided, then the media content will be enabled for playback. Alternatively, when the file is requested to be played, the media server can make a query to a local database or storage device containing digital rights information in order to verify the appropriate digital rights have been obtained for the media content in order to enable playback of the media content.

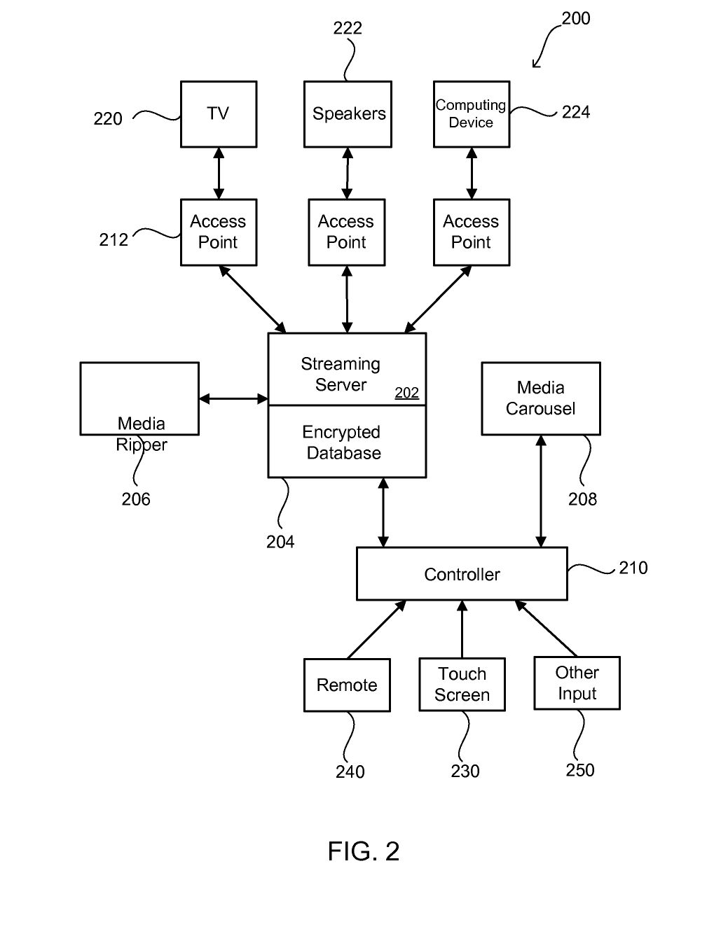

An output device can be provided to receive media content from the media server and to reproduce the media content for an end user. FIG. 2 illustrates examples of output devices that may include but are not limited to video output 220, audio output 222 or other multi-media outputs 224 (and 124 in FIG. 1). The output devices may receive content through an access point 212 which is configured to receive media content from the media server and send the media content to an output device. The access point may be a wireless set-top box, a network router, a network endpoint, or another networkable device which is configured to forward packets of information to the multi-media output device.

FIG. 2 illustrates that a media controller 210 can be connected to a media carousel 208 in order to provide control signals to the media carousel and to interface the media carousel with the media server. The controller can also provide control signals to the streaming media server 202.

An example of a media carousel is a DVD home theater carousel that is configured to store anywhere from 3 to 200+ DVDs at a time and can provide the ability to read media content from the DVDs. This allows many DVDs or many purchased copies of program material to be physically checked which in turn enables the many media programs stored by the encrypted storage for the server to be played back when the physical media exists that corresponds to a purchased copy of the program.

In one embodiment, the media controller is configured to receive instructions from the end user about the programs that are desired to be played. These control instructions can be input using a remote control 240, touch screen 230, voice commands or other known input devices 250 or methods. This control information is then passed from the controller on to the media server which may stream or distribute the media program out to the appropriate access point 212. Then the media program can be played by the output device attached to the access point. Examples of output devices include, but are not limited, to televisions 220, audio speakers 222, monitors, computing devices 224, video walls, PDAs, iPods, or any other type of device that enables the playback of media content to an end user.

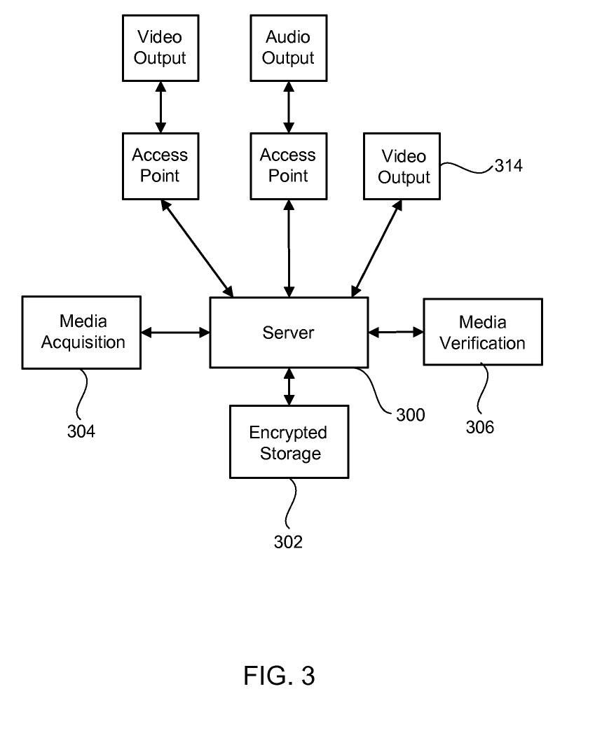

FIG. 3 illustrates a system configuration where the server 300 communicates directly with the media verification device 306. Similarly, an output device such as a video output 314 can be connected directly to the server for video output. The encrypted storage 302 for the media content may be an independent device that is in networked communication with the server. For example, a network attached storage device LAS) can be used. Further, the media acquisition device 304 and media verification device 306 may not be directly connected to the server but may be in communication with the server via a wireless network connection or another network connection.

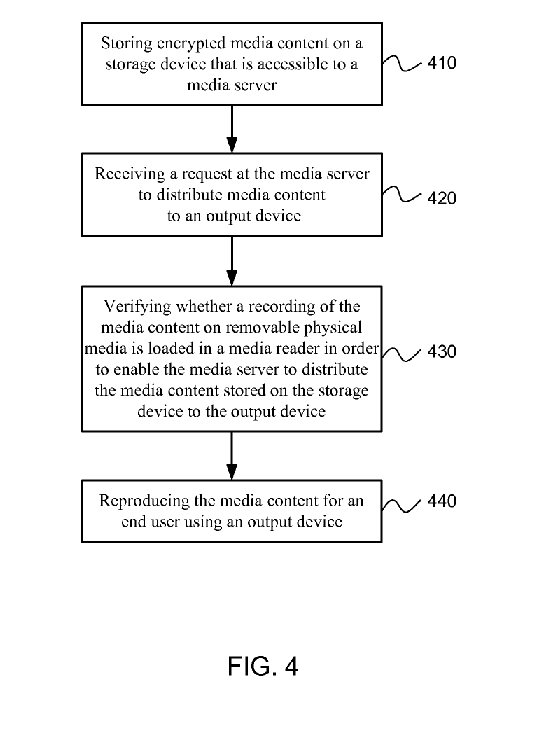

FIG. 4 is a flowchart illustrating a method for enabling distribution of media content across a network using verification. The method includes the operation of storing encrypted media content on a storage device that is accessible to a media server, as in block 410. Then a request can be received by the media server to distribute media content to an output device, as in block 420. The request can be received directly from a user or received from a programmed control device or software module, such as a timer or scheduler.

Another operation is verifying whether a recording of the media content on removable physical media is loaded in a media reader, as in block 430. The verification takes place in order to enable the media server to distribute the media content stored on the storage device to the output device. As mentioned, the media reader may be a carousel disk optical player.

The server can check for the existence of the recorded media content on removable physical media after the media content has started playback in order to determine whether playback is allowed to continue. Alternatively, the existence of the DVD, CD, or Blu-Ray disk can be verified before the media content playback is allowed to start.

The media content can then be reproduced for an end user using an output device, as in block 440. The media content can be distributed to the output device via an access point and an end user can view or listen to the media program.

It is to be understood the system may be configured to acquire, store, access and output non-encrypted and/or non-protected media as well as encrypted or protected media. Where media is not protected or encrypted, the system may be configured to recognize this and may bypass verification of the presence of the physical media. It is contemplated that such media may be in the form of home videos, personal audio recordings and the like, but may encompass any form of non-protected media.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for enabling distribution of media content across a network using physical verification, comprising:
a media server configured to send media content across a local network;
a storage device in communication with the media server, the storage device being configured to store media content having encryption and to provide the media content to the media server;
a media reader in communication with the media server, wherein the media reader is checked by the media server to determine whether a recording of the media content on removable physical media is loaded in the media reader in order to allow the media server to distribute the media content previously stored on the storage device; and
an output device enabled to receive media content from the media server and to reproduce the media content for an end user.

2. A system as in claim 1, further comprising an access point configured to receive media content from the media server and send the media content to an output device.

3. A system as in claim 1, further comprising a media acquisition device configured to electronically extract the media content from a removable physical recording medium.

4. A system as in claim 3, wherein the media acquisition device is an optical reader module configured to read an optical recording disk and decrypt the media content.

5. A system as in claim 1, wherein the media reader is checked for the existence of a purchased recording on removable physical media after the media content has started playback in order to determine whether playback is allowed to continue.

6. A system as in claim 1, wherein the media reader is checked for the existence of a purchased recording of the media content on removable physical media before the media content can be sent

7. A system as in claim 1, wherein the media reader is checked for the existence of a purchased recording of the media content on removable physical media after at least a portion of the media content is sent but before the media content has started playback.

8. A system as in claim 1, further comprising a media controller that is connected to the media reader in order to provide control signals to the media reader and to interface with the media server.

9. A system as in claim 1, wherein the storage device receives media content from a media service via the internet and the media reader verifies digital rights to the media content received from the media service.

10. A system as in claim 1, wherein the media reader is checked by the media server: every time before distribution of media content, periodically before distribution of media content, or randomly before distribution of media content.

11. A system as in claim 1, wherein the media server streams the media content synchronized to clocks in the media server and receiving points.

12. A system as in claim 1, wherein the media server distributes the media content asynchronously.

13. A method for enabling distribution of media content across a network using verification, comprising:
storing encrypted media content on a storage device that is accessible to a media server;
receiving a request at the media server to distribute media content to an output device;
verifying whether a recording of the media content on removable physical media is loaded in a media reader in order to enable the media server to distribute the media content stored on the storage device to the output device; and
reproducing the media content for an end user using an output device.

14. A method as in claim 15, further comprising the step of distributing media content to an output device via an access point.

15. A method as in claim 15, further comprising the step of using a media reader that is a carousel disk optical player.

16. A system for enabling distribution of media content across a network using physical verification, comprising:
a media server configured to send media content across a local network;
a database in communication with the media server, the database being configured to store media content having encryption and to provide the media content to the media server;
an optical reader configured to electronically extract the media content from an optical disk;
an optical media carousel, configured to hold and read the optical disk, and in communication with the media server; and
an output device enabled to receive media content from the media server and to reproduce the media content for an end user.

17. A system in accordance with claim 18, further comprising a controller connected to the media carousel to provide control signals to the media carousel and to interface the media carousel with the media server.

18. A system in accordance with claim 18, wherein the media server is a streaming media server.

19. A system in accordance with claim 18, wherein the optical media carousel is checked by the media server to determine whether the physical media of a recording of the media content is physically in the media carousel in order to allow the media server to distribute the media content previously stored in the database.

20. A system in accordance with claim 18, wherein the database is checked by the media server to distribute media content previously stored in the database to determine at least one of: digital rights to the media content, past physical presence of the physical media of a recording of the media content, or present physical presence of the physical media of a recording of the media content.

21. A system in accordance with claim 18, wherein an online media service is checked by the media server to distribute media content received from the online media service and previously stored in the database to determine digital rights to the media content.

22. A system in accordance with claim 18, wherein the optical disk is a DVD.
